(19) United States
(12) Patent Application Publication
(10) Pub. No.: US 2026/0148088 A1
(43) Pub. Date: May 28, 2026

(54) Method for Generating Common Model Through Artificial Neural Network Model Training Result Synthesis

(71) Applicant: ACRYL INC., Seoul (KR)

(72) Inventors: Wei Jin Park, Seoul (KR); Hyun Kyeong Shin, Seoul (KR); Kyung Jun Lee, Seoul (KR); Joo Yeop Song, Yeongtong-gu Suwon-si Gangwon-do (KR); Do Youn Chang, Seoul (KR); Chan Yong Kim, Seoul (KR)

(21) Appl. No.: 19/122,050

(22) PCT Filed: Dec. 22, 2022
(86) PCT No.: PCT/KR2022/021023

§ 371 Date: Jun. 24, 2025

(30) Foreign Application Priority Data
May 19, 2022 (KR) 10-2022-0061586

(51) Int. Cl. G06N 3/096

(52) U.S. Cl. CPC G06N 3/096

(57) ABSTRACT

The present invention relates to a server operation method in which base institutions are operated in various regions, and artificial neural network models are shared among institutions to provide services. A method of operating a central server according to one embodiment comprises the steps of: receiving training results of artificial neural network models trained individually from a plurality of individual servers; generating a common model on the basis of the training results; and transmitting the common model to the plurality of individual servers.

### TECHNICAL FIELD

The following embodiments relate to a method of operating a server that provides a service by sharing an artificial neural network model among institutions because branch institutions are operated in multiple regions.

### BACKGROUND ART

An artificial neural network (ANN) may be a statistical learning algorithm inspired by a biological neural network (especially the brain among central nervous systems of animals) in machine learning and cognitive science. The ANN may indicate a general model having the ability to solve a problem as artificial neurons (nodes) forming the network through synaptic combination change connection strength of synapses by learning.

### DISCLOSURE OF THE INVENTION

### Technical Goals

Embodiments provide a method of operating a central server including receiving training results of artificial neural network (ANN) models that are individually trained from a plurality of individual servers, synthesizing the training results of the ANN models in a central server, and generating a common model.

Embodiments provide a method of operating a central server including transmitting a common model generated by the central server to each of a plurality of individual servers.

Embodiments provide a method of operating an individual server including updating an ANN model of the individual server using a common model received from a central server.

The technical goals to be achieved by the present invention are not limited to those described above, and other technical goals not mentioned above can be clearly understood from the following description and accompanying drawings by one having ordinary skill in the technical field to which the present invention pertains.

### Technical Solutions

According to an embodiment, a method of operating a central server includes receiving, from a plurality of individual servers, training results of artificial neural network (ANN) models that are individually trained, generating a common model based on the training results, and transmitting the common model to the plurality of individual servers.

According to an embodiment, the generating of the common model may include generating a list of individual servers that completed receiving the training results, and generating the common model based on the list.

According to an embodiment, the generating of the common model may include generating the common model based on a mean value of the training results.

According to an embodiment, the generating of the common model may include determining a confidence of each of the plurality of individual servers, determining a weight of each of the plurality of individual servers based on the confidence, and generating the common model based on the weight of each of the plurality of individual servers.

According to an embodiment, the determining of the weight may include comparing the confidence of each of the plurality of individual servers with a predetermined threshold value, and when the confidence of each of the plurality of individual servers is less than the predetermined threshold value, setting a weight of a corresponding server to “0”.

According to an embodiment, the method may further include inputting the confidence of each of the plurality of individual servers to a softmax layer and normalizing the confidence.

According to an embodiment, the determining of the confidence may include evaluating performance of the ANN model of each of the plurality of individual servers by comparing the training results with the common model, and updating the confidence based on the evaluation result.

According to an embodiment, the determining of the confidence may include determining the confidence based on contextual information received from each of the plurality of individual servers.

According to an embodiment, a method of operating an individual server includes transmitting a training result of an ANN model to a central server, receiving a common model from the central server, and updating the ANN model using the common model, wherein the common model is generated based on training results that the central server receives from a plurality of servers including the individual server.

According to an embodiment, a non-transitory computer-readable storage medium stores instructions that, when executed by a processor, cause the processor to perform the method.

According to an embodiment, a central server device includes a receiver configured to receive, from a plurality of individual servers, a training result of an ANN model that is individually trained, a processor configured to generate a common model based on the training results, and a transmitter configured to transmit the common model to the plurality of individual servers.

According to an embodiment, the processor may be further configured to generate a list of individual servers that completed receiving the training results, and generate the common model based on the list.

According to an embodiment, the processor may be further configured to generate the common model based on a mean value of the training results.

According to an embodiment, the processor may include a confidence determiner configured to determine a confidence of each of the plurality of individual servers, and a weight determiner configured to determine a weight of each of the plurality of individual servers based on the confidence, wherein the common model may be generated based on the weight of each of the plurality of individual servers.

According to an embodiment, the weight determiner may include a comparator configured to compare the confidence of each of the plurality of individual servers with a predetermined threshold value and when the confidence of each of the plurality of individual servers is less than the predetermined threshold value, set a weight of a corresponding individual server to “0”.

According to an embodiment, the confidence of each of the plurality of individual servers may be input to a softmax layer and be normalized.

According to an embodiment, the confidence determiner may be configured to evaluate performance of the ANN model of each of the plurality of individual servers by comparing each of the training results with the common model, and update the confidence based on the evaluation result.

According to an embodiment, the confidence determiner may be configured to determine the confidence based on contextual information received from each of the individual servers.

According to an embodiment, an individual server device may include a transmitter configured to transmit a training result of an ANN model to a central server, a receiver configured to receive a common model from the central server, a processor configured to update the ANN model using the common model, wherein the common model may be generated based on training results that the central server receives from a plurality of servers including the individual server.

### BRIEF DESCRIPTION OF DRAWINGS

FIG. 1 schematically illustrates a process of updating an artificial neural network (ANN) model according to an embodiment.

FIG. 2 is a block diagram schematically illustrating a method of operating a central server.

FIG. 3 is a block diagram schematically illustrating a process of generating a common model by a central server.

FIG. 4 schematically illustrates a process of generating a common model by determining a weight of each individual server.

FIG. 5 is a block diagram schematically illustrating a method of operating an individual server.

### BEST MODE FOR CARRYING OUT THE INVENTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

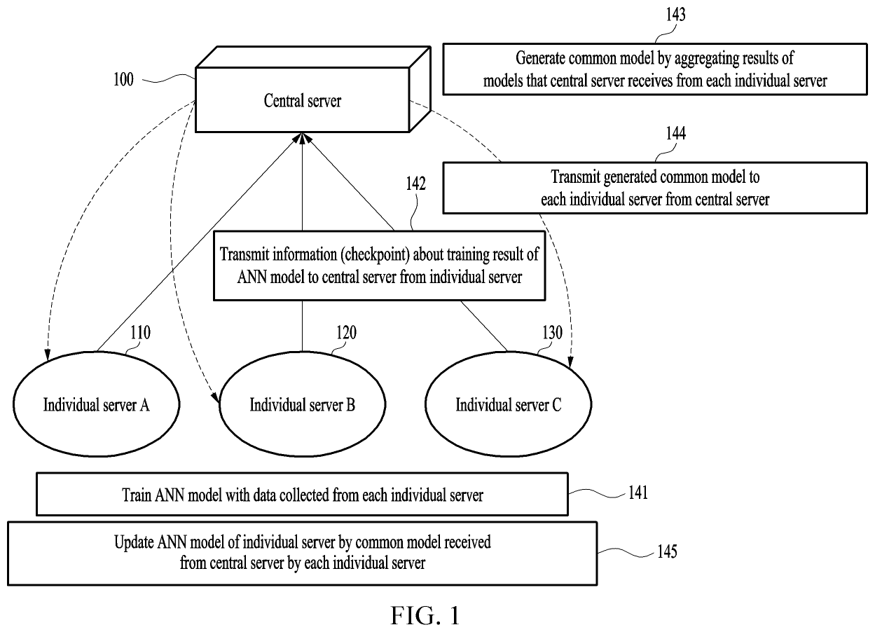

FIG. 1 schematically illustrates a process of updating an artificial neural network (ANN) model according to an embodiment.

Referring to FIG. 1, an ANN model update system in an embodiment may include a central server 100 and a plurality of individual servers (e.g., an individual server A 110, an individual server B 120, and an individual server C 130) as entities, and the individual servers are not limited to the individual server A 110, the individual server B 120, and the individual server 130 shown in the drawings and may include multiple servers. One or more blocks of FIG. 1 or a combination thereof may be implemented by a special-purpose hardware-based computer configured to perform a specific function or a combination of computer instructions and special-purpose hardware.

The central server 100 in an embodiment may be a server installed in a central institution that may control or monitor individual servers (multiple servers other than 110 to 130) installed in multiple institutions. The central server 100 may be connected to each of the plurality of individual servers (e.g., the individual server A 110, the individual server B 120, and the individual server C 130) via a network (not shown). In this case, the network may include the Internet, one or more local area networks, wire area networks, a cellular network, a mobile network, other types of networks, or a combination thereof.

The individual servers (multiple servers other than 110 to 130) in an embodiment may be a server equipped with a network environment and installed in an institution having branches in multiple regions. The individual servers may train and build each ANN model and may share or transmit/receive the ANN model via a network connected to the central server.

The “institution” according to an embodiment may include a medical institution, a financial institution, a healthcare service company, a personal information management institution, a public institution, a military institution, and etc. Hereinafter, for ease of description, the “institution” is described based on a medical institution (e.g., a hospital), but the “institution” is not limited to the medical institution. The institution operating an ANN model service may retain a graphics processing unit (GPU) server group for ANN model training and may operate branch institutions in multiple regions to provide the service by sharing the ANN model among institutions. Hereinafter, the service provided by the institution based on the ANN model is referred to as an artificial intelligence (AI) service. The institution may provide the AI service by building different ANN models for each individual branch based on data of each institution.

Model training may need to be performed using a vast volume of data by collecting all data pieces collected by each institution to update the ANN model. However, in an institution with a high data security level, model training may be performed with a small amount of data in each institution because data export is prohibited. In other words, in the case of an institution securing branches in multiple regions, each branch may not provide the same AI service due to the data export issue. Accordingly, it may be difficult to improve the performance when developing an AI model with limited data obtained from a single institution. For example, when a special case occurs in institution A, an AI service advanced using the data may be operated only by institution A and institution B may not use the AI service.

As described below, the central server 100 may receive parameters of AI models trained by the plurality of individual servers (e.g., the individual server A 110, the individual server B 120, and the individual server C 130), respectively, may generate a common model, and may transmit the generated common model to the plurality of individual servers (e.g., the individual server A 110, the individual server B 120, and the individual server C 130).

More specifically, a process of updating an ANN model according to an embodiment may include a process 141 of training an ANN model with data collected by each individual server, a process 142 of transmitting information (a checkpoint) about an AI model training result by each individual server, a process 143 of generating a common model by aggregating results of models that the central server receives from each individual server, a process 144 of transmitting the generated common model by the central server to each individual server, and a process 145 of updating the ANN model of each individual server by the common model that each individual server receives from the central server. Operations 141 to 145 illustrated in FIG. 1 may be iteratively performed and accordingly, the ANN models of the individual servers and the common model of the central server 100 may be continuously updated.

For example, in an operation of the individual server A 110 in an embodiment, an ANN model may be trained 141 by the individual server A 110 with data collected from the institution A in which the individual server A 110 is installed. The individual server A 110 may train the ANN model based on the data collected from the institution A. The individual server A 110 may transmit 142 the information (checkpoint) about a result of training the ANN model to the central server. In this case, the information (checkpoint) about the result of training the ANN model may be information about the ANN model that is trained 141 by itself in the individual server A 110. In other words, the individual server A 110 may prevent a security issue such as data export in advance by transmitting a parameter of the trained ANN model to the central server 100 without transmitting training data used for training the ANN model. Other individual servers (e.g., the individual server B 120 and the individual server C 130) may also transmit respective parameters of the trained ANN models to the central server 100 like the individual server A 110.

When the central server 100 synthesizes information about the training result of the ANN model received from individual institutions and transmits 144 a common model to the individual server A 110, the individual server A 110 may receive the common model and may update the ANN model of the individual server A 110. The example is not limited to the individual server A 110 and may apply to other individual servers, and the operations may be iteratively performed at least once on each individual server.

According to the ANN model update system, the central server 100 may provide the same AI service to institutions managed by the central server 100 without a security issue, such as data export.

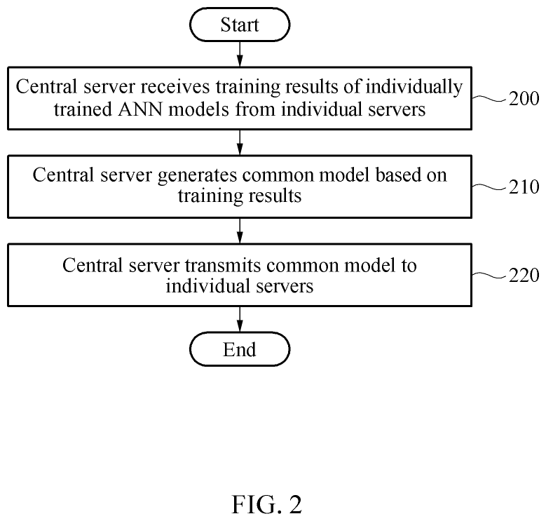

FIG. 2 is a block diagram schematically illustrating a method of operating a central server according to an embodiment.

The description provided with reference to FIG. 1 may apply to the description with reference to FIG. 2, and a repeated description may be omitted.

Referring to FIG. 2, a central server may receive 200 training results of ANN models that are individually trained by a plurality of individual servers, may generate 210 a common model based on the training results, and may transmit 220 the common model to the plurality of individual servers.

More specifically, in operation 200 of receiving the training results of ANN models, the training results may be results of building ANN models by the plurality of individual servers. In other words, the central server may receive each ANN model and may generate 210 a common ANN model based on the training results of the ANN models. The individual server may not transmit raw data individually used for training to the central server.

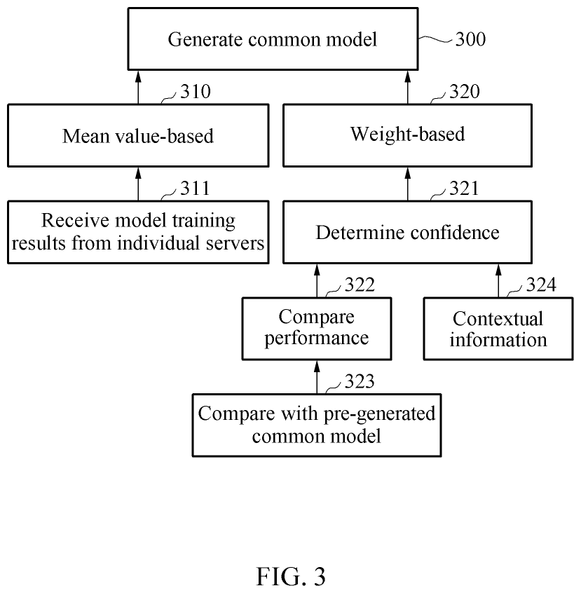

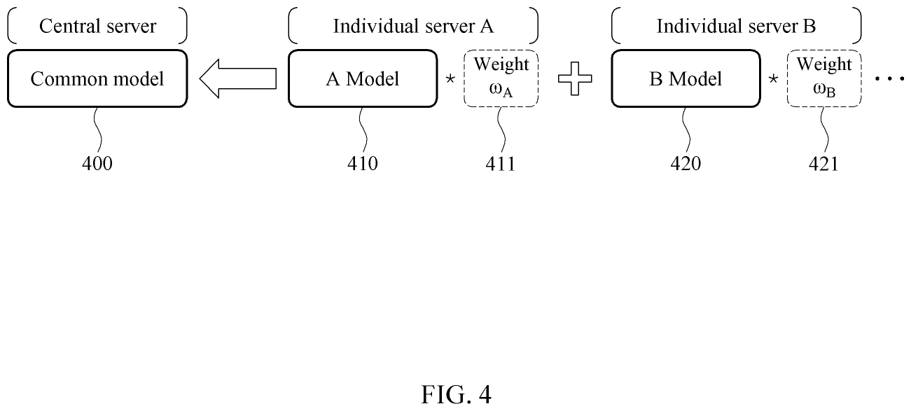

The common model may be an ANN model generated by the central server through a series of processes and may be an ANN model in which the trained ANN models of the plurality of individual servers are synthesized. Generating the common model may indicate determining a parameter (e.g., a weight) of the common model. The process of generating the common model by the central server is further described with reference to FIGS. 3 and 4. The central server may transmit 220 the common model to each of the plurality of individual servers.

FIG. 3 is a block diagram schematically illustrating a process of generating a common model by a central server, according to an embodiment.

The description provided with reference to FIGS. 1 and 2 may apply to the description provided with reference to FIG. 3, and a repeated description may be omitted.

Referring to FIG. 3, an operation of generating 300 a common model by the central server 100 may consider both an operation of basing 310 on a mean value and an operation of determining 320 of a weight. The process of basing 310 on the mean value may include a process of generating a common model by receiving 311 a model training result from the plurality of individual servers. The operation of determining 320 the weight may include an operation of determining 321 confidence, and the operation of determining 321 the confidence may include an operation of comparing 322 the performance of ANN models or an operation of receiving contextual information 324, and the operation of comparing 322 the performance may include an operation of comparing 323 with a pre-generated common model.

More specifically, the operation of generating 300 the common model may be a model generated based 310 on the mean value, a model generated by determining 320 the weight, or a model generated by synthesizing the model generated based 310 on the mean value and the model generated by determining 320 the weight.

The operation of basing 310 the mean value may be an operation of considering and aggregating values of layers of respective ANN models as the same weight and calculating the mean. The operation 311 of receiving the model training result from the plurality of individual servers may include an operation of generating a list of individual servers that completed receiving the training results and an operation of generating the common model based on the list.

The operation of generating 300 of the common model may include an operation of determining confidence of each of the plurality of individual servers, an operation of determining a weight of each of the plurality of individual servers, and an operation of generating a common model based on a weight of each of the plurality of individual servers.

The operation of determining 320 of the weight may further include an operation of comparing the confidence of each of the plurality of individual servers with a predetermined threshold value and when the confidence of each of the plurality of individual servers is less than the predetermined threshold value, an operation of setting a weight of the corresponding individual server to 0. As the confidence according to an embodiment increases, the weight of the corresponding individual server may be determined to be higher. To prevent the discriminatory ability of the weight from being reduced because the confidence is biased, the operation of determining 320 of the weight may include an operation of inputting the confidence of each of the plurality of individual servers to a softmax layer and normalizing the confidence.

The operation of determining 321 the confidence may include an operation of evaluating the performance of the ANN model of each of the plurality of individual servers by comparing the training result with the common model and an operation of updating the confidence based on the evaluation result. The operation of determining 321 the confidence may include an operation of determining the confidence based on the contextual information received from each individual server. The contextual information may be information about a special situation directly received from each individual server. For example, the contextual information may be about a factor determined by each medical institution to significantly increase or decrease a weight of the corresponding individual server.

In operation 323 of comparing the pre-generated common model in the central server with the ANN model of the individual server, the pre-generated common model may be a model generated based 310 on a mean value, may be a model generated by determining 320 the weight, or may be a common model generated by synthesizing the model based 310 on the mean value and the model generated by determining 320 the weight.

For example, when there is no common model generated by determining 320 the weight, the common model may be preferentially generated 300 based on the mean value, and then, data obtained by comparing the performance of the ANN model of each individual server with the performance of the common model may be quantified, the confidence may be determined by comparing a value of each individual server based on the quantified data, and the contextual information about the case where the ANN model of the individual server that reflects a special situation (data that other institutions or servers do not learn) exists may be reflected in the operation of determining the confidence.

As another example, the central server may determine the confidence using an attention layer. For example, the central server may determine an attention weight by input the data received from the individual servers to the attention layer and may use the attention weight as the confidence.

The central server may generate the common model by determining the weight based on the determined confidence. Thereafter, operation 300 of generating the common model may include an operation of generating the common model by re-synthesizing the model based 310 on the mean value and the model generated by determining 320 the weight.

FIG. 4 schematically illustrates a process of generating a common model by determining a weight of each individual server according to an embodiment.

The description provided with reference to FIGS. 1 to 3 may apply to the description provided with reference to FIG. 4, and a repeated description may be omitted.

Referring to FIG. 4, a process of generating a common model by determining a weight may include a process of reflecting a weight ω_{A} 411 in a training result of a model A 410, reflecting a weight ω_{B} 421 in a training result of a model B 420, and adding them, and may further include a process of reflecting and adding an individual weight in a training result of an ANN model of a plurality of individual servers. In the process of generating the common model described above, the number of ANN models is not limited, the operation of reflecting the weight is not limited to multiplication as shown in FIG. 4 and is not limited to adding a model reflecting the weight to the model of each individual server, and the common model may be generated in various methods using an aggregation function.

A central server 400 in an embodiment may generate a list of individual servers that received training results and may generate a common model based on the generated list. Among the plurality of individual servers, a parameter of an ANN model that is not trained may not be reflected in the common model. For example, the individual server may transmit the training result together with an acknowledgment (ack) signal. The central server 400 may consider the received training result and the ack signal in generating the common model.

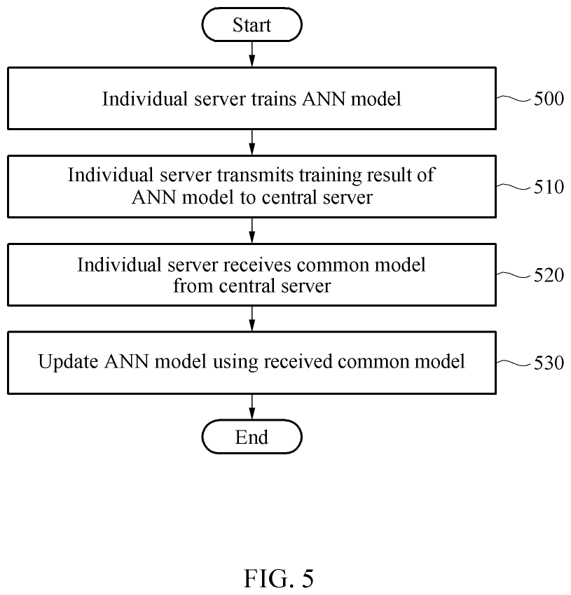

FIG. 5 is a block diagram schematically illustrating a method of operating an individual server.

The description provided with reference to FIGS. 1 to 3 may apply to the description provided with reference to FIG. 5, and a repeated description may be omitted.

Referring to FIG. 5, a method of operating an individual server may include operation 500 of training an ANN model, operation 510 of transmitting a training result of the ANN model to a central server, operation 520 of receiving a common model from the central server, and operation 530 of updating the ANN model using the received common model.

More specifically, the individual server may be trained based on data of an institution in which the individual server is installed. The individual server in an embodiment may provide an AI server with a small amount of data because data export may be prohibited depending on a security level.

The individual server may transmit a training result of the ANN model to the central server. In this case, when data export is prohibited depending on the security level of the individual server, only a parameter according to the training result of the ANN model other than the data may be transmitted.

The individual server may receive a common model generated by the central server. The information about the common model received from the central server may include a parameter of the common model and may further include data of individual servers of other institutions depending on the security levels of other institutions.

The individual server may update the ANN model of the individual server using the parameter of the received common model. The updated ANN model in an embodiment may be an ANN model to which an optimal parameter including the parameter of the common model is applied.

With reference to FIGS. 1 to 5, the ANN model update system described above may be repeated at least once and as the repetition increases, the quality of the AI service of the individual server may be improved. Accordingly, institutions that are forced to provide AI services with a small amount of data because data export of the individual servers is prohibited may provide better AI services by updating the AI services through the common model based on a vast amount of data.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. A method of operating a central server, the method comprising:
receiving, from a plurality of individual servers, training results of artificial neural network (ANN) models that are individually trained;
generating a common model based on the training results; and
transmitting the common model to the plurality of individual servers.

2. The method of claim 1,
wherein the generating of the common model comprises:
generating a list of individual servers that completed receiving the training results; and
generating the common model based on the list.

3. The method of claim 1,
wherein the generating of the common model comprises:
generating the common model based on a mean value of the training results.

4. The method of claim 1,
wherein the generating of the common model comprises:
determining a confidence of each of the plurality of individual servers;
determining a weight of each of the plurality of individual servers based on the confidence; and
generating the common model based on the weight of each of the plurality of individual servers.

5. The method of claim 4,
wherein the determining of the weight comprises:
comparing the confidence of each of the plurality of individual servers with a predetermined threshold value; and
when the confidence of each of the plurality of individual servers is less than the predetermined threshold value, setting a weight of a corresponding server to “0”.

6. The method of claim 4, further comprising:
inputting the confidence of each of the plurality of individual servers to a softmax layer and normalizing the confidence.

7. The method of claim 4,
wherein the determining of the confidence comprises:
evaluating performance of the ANN model of each of the plurality of individual servers by comparing the training results with the common model; and
updating the confidence based on the evaluation result.

8. The method of claim 4,
wherein the determining of the confidence comprises:
determining the confidence based on contextual information received from each of the plurality of individual servers.

9. A method of operating an individual server, the method comprising:
transmitting a training result of an artificial neural network (ANN) model to a central server;
receiving a common model from the central server; and
updating the ANN model using the common model,
wherein the common model is generated based on training results that the central server receives from a plurality of servers comprising the individual server.

10. A non-transitory computer-readable storage medium storing instructions that, when executed by a processor, cause the processor to perform the method of claim 1.

11. A central server device comprising:
a receiver configured to receive, from a plurality of individual servers, a training result of an artificial neural network (ANN) model that is individually trained;
a processor configured to generate a common model based on the training results; and
a transmitter configured to transmit the common model to the plurality of individual servers.

12. The central server device of claim 11,
wherein the processor is further configured to:
generate a list of individual servers that completed receiving the training results, and
generate the common model based on the list.

13. The central server device of claim 11,
wherein the processor is further configured to:
generate the common model based on a mean value of the training results.

14. The central server device of claim 11,
wherein the processor comprises:
a confidence determiner configured to determine a confidence of each of the plurality of individual servers; and
a weight determiner configured to determine a weight of each of the plurality of individual servers based on the confidence,
wherein the common model is generated based on the weight of each of the plurality of individual servers.

15. The central server device of claim 14,
wherein the weight determiner comprises:
a comparator configured to compare the confidence of each of the plurality of individual servers with a predetermined threshold value and when the confidence of each of the plurality of individual servers is less than the predetermined threshold value, set a weight of a corresponding individual server to “0”.

16. The central server device of claim 14, wherein the confidence of each of the plurality of individual servers is input to a softmax layer and is normalized.

17. The central server device of claim 14,
wherein the confidence determiner is configured to:
evaluate performance of the ANN model of each of the plurality of individual servers by comparing each of the training results with the common model, and
update the confidence based on the evaluation result.

18. The central server device of claim 14,
wherein the confidence determiner is configured to determine the confidence based on contextual information received from each of the individual servers.

19. An individual server device comprising:
a transmitter configured to transmit a training result of an artificial neural network (ANN) model to a central server;
a receiver configured to receive a common model from the central server;
a processor configured to update the ANN model using the common model,
wherein the common model is generated based on training results that the central server receives from a plurality of servers comprising the individual server.
